(19) United States
(12) Patent Application Publication
(10) Pub. No.: US 2008/0111842 A1
(43) Pub. Date: May 15, 2008

(54) Method and system for ink consumption monitoring

(75) Inventors: Jeffrey S. Hall, Shelton, CT (US); Keith M. Smith, Fairfield, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/595,434

(22) Filed: Nov. 9, 2006

(51) Int. Cl. B41J 2/195

(52) U.S. Cl. 347/7

(57) ABSTRACT

A method and system for predicting ink usage during a print job for an ink jet printer and displaying information in connection with ink usage on a system monitor. The method steps include determining the initial ink level of an ink cartridge and developing a histogram of ink usage associated with a threshold number of items to be printed. The threshold number is less than the total number of items to be printed and should be an amount representative of each of the print items. The usage associated with the threshold number, i.e., the histogram, may then be extrapolated to evaluate the number of items which can be printed before the ink cartridge is depleted. The number of items which can be printed is then displayed to the user/operator on a system monitor so that a determination can be made concerning whether the print job may be completed. Additionally, the time remaining and/or the ink cartridge to be depleted first can be displayed to provide additional information to the operator concerning the replacement/replenishment of ink cartridges.

### TECHNICAL FIELD

This invention relates to ink cartridges for ink-jet printers, and more particularly, to a new and useful method and system for predicting the usage of ink to determine whether a print job may be completed using currently installed ink cartridges.

### BACKGROUND ART

Ink-jet printers typically use one or more ink cartridges to print black and/or color images. In-line printers used for printing on mailpieces oftentimes employ multiple ink cartridges for printing the various “zones” on a mailpiece (or package) including zones for the return address, mailing address, and barcode symbology. Generally, it is these ink cartridges that account for a large portion, if not the largest portion, of the overall life cycle costs associated with the operation of such printers. In fact, the cost of a single set of ink-cartridges can approach the cost of the original printer (which typically has installed an initial set of cartridges).

In view of these operating expenses, it is important to know when these ink cartridges will be depleted, particularly when one ink cartridge may be “Ink Out” before several others when performing the same print job. For example, there is a high probability that an ink cartridge dedicated to printing the barcode symbology will, due to the relatively large ink requirements associated therewith, run out of ink before a neighboring ink cartridge dedicated to printing, for example, a line of the return address. If an operator is unaware that one of the ink cartridges is out, then hundreds of mailpieces may be missing a necessary print element before the misprint is noticed. As such, the mail run may require reprint resulting in lost operator time, wasted ink and/or a multiplicity of reject mailpieces.

Currently, printers and/or systems monitoring a print job will display the current ink level available within a cartridge. That is, an operator is provided with information regarding the percentage of ink remaining as compared to a full ink cartridge. When the display reveals a low ink level, the operator must either (i) carefully monitor the ink level as it approaches an ink out condition or (ii) remove and replace the ink cartridge prematurely (which may still contain five to ten percent) with a full cartridge. Inasmuch as option (ii) is more often selected for convenience, valuable ink is often discarded to negate the expense or embarrassment of operator error.

Other printers and/or systems display predictive data to a user/operator in connection with the number of pages which may be printed based upon the remaining volume of ink in a cartridge. That is, a printer may display the number of pages which may be printed based upon the current ink level of the ink cartridge. While such displays provide an estimate of potential print capacity, the estimate is based simply upon the ink consumption of a typical printed page. If, for example, a user/operator is printing a series of photographs (which consumes a far greater amount of ink than a typical printed page), the displayed estimate cannot be relied upon to accurately measure or determine the sufficiency of ink to print the series of photographs. That is, since the average ink consumption may be based upon the usage associated with printing a letter-sized sheet having thirty (30) lines of printed subject matter per page, a photograph consumes a far greater volume of ink and no longer is representative of the ink consumption average used to predict future print capacity. It will, therefore, be appreciated that the current predictive techniques do not rely upon the unique characteristics of a particular print job, but simply upon a predetermined, historical average of ink consumption of an average user producing a typical sheet of printed material.

A need, therefore, exists for a method and system for accurately predicting the usage of ink to determine whether a print job may be completed.

### BRIEF DESCRIPTION OF THE DRAWINGS

The accompanying drawings illustrate presently preferred embodiments of the invention and, together with the general description given above and the detailed description given below serve to explain the principles of the invention. As shown throughout the drawings, like reference numerals designate like or corresponding parts.

FIG. 1 is a diagram of the various system elements and the functional interrelationships therebetween for performing the method of the present invention including a processor, a printer having a plurality of ink cartridges, program code for executing the predictive ink usage algorithms, and a system monitor for displaying information to a user/system operator.

FIG. 2 illustrates various print zones associated with printing mailpieces wherein a singular ink cartridge is dedicated to printing characters and images within respective print zones.

FIG. 3 is a flow diagram of the inventive method for predicting ink usage wherein the prediction algorithms are based upon a histogram a threshold number of printed items, an evaluation of the print stream or and evaluation of the documents (e.g., mailpieces) to be printed.

FIG. 4 is a first table of input/output data associated with empirically derived histogram data to predict ink usage for a mailpiece print job.

FIG. 5 is an exemplary display of information presented to an operator by a monitoring system, including information relevant to the number of pieces which may be printed, the time before ink out and the print cartridge having the lowest ink level.

FIG. 6 is a second table of input/output data associated with calculated print stream/document to predict ink usage for a mailpiece print job.

### SUMMARY OF THE INVENTION

A method and system is provided for predicting ink usage during a print job for an ink jet printer and displaying information in connection with ink usage on a system monitor. The method steps include determining the initial ink level of an ink cartridge and developing a histogram of ink usage associated with a threshold number of items to be printed. The threshold number is less than the total number of items to be printed and should be an amount representative of each of the print items. The usage associated with the threshold number, i.e., the histogram, may then be extrapolated to evaluate the number of items which can be printed before the ink cartridge is depleted. The number of items which can be printed is then displayed to the user/operator on a system monitor so that a determination can be made concerning whether the print job may be completed. Additionally, the time remaining and/or the ink cartridge to be depleted first can be displayed to provide additional information to the operator concerning the replacement/replenishment of ink cartridges.

### DETAILED DESCRIPTION

The present invention is described in the context of an in-line printer for printing various zones on the face of a mailpiece, though the invention is applicable to any ink-jet printer wherein knowledge of an ink out condition is desirable.

Ink cartridges have a predetermined quantity of ink therein, which may be measured in various volumetric terms. For example, an HP45A ink cartridge, manufactured by Hewlett Packard, located in Palo Alto, Calif., contains about forty-two milliliters (42 mL) of ink. Irrespective the volumetric measurement, whether in liters, ounces etc., all can be converted to a number of ink drops wherein each drop corresponds to a predetermined quantity of ink delivered with each pulse or bubble of ink projected from the ink jet nozzles. A typical pulse or droplet of ink produces a small bubble or sphere which is about 50-60 microns in diameter or about 50-60×10⁻⁶ meters. The volume of the ink sphere in cubic meters (m³) is given by the relationship (1.0) below:

V(cubic meters)=4/3(π)(d/2)³ (1.0)

wherein d is the diameter of the ink sphere. According to equation 1.0, the volume of a typical ink droplet is about 1.13×10⁻¹³ m³.

Inasmuch as a typical ink cartridge contains about 0.042 liters of ink, the total number of ink droplets is given by equations (2.0 and 3.0) below:

1 m³ (1.13×10⁻¹³)=1000 liters (1.13×10⁻¹³)=1.13×10⁻¹⁰ liters (2.0)

X=0.042 liters/(1.13×1010⁻¹⁰ liters)=3.72×10⁸ (3.0)

wherein X is the number of ink droplets which can be delivered from a forty-two (42) milliliter ink cartridge.

Surprisingly, the measurement in terms of ink drops within each cartridge is highly accurate and can be relied upon with about a one percent (±1%) error factor. Consequently, since the number of ink drops (also analogous to the pixels of an image) required to print a character e.g., the letter “T” in Times New Roman font at a 12 point size is known, then the cumulative number of ink drops associated with an entire page or document can also be determined. This determination may be derived empirically or via calculation.

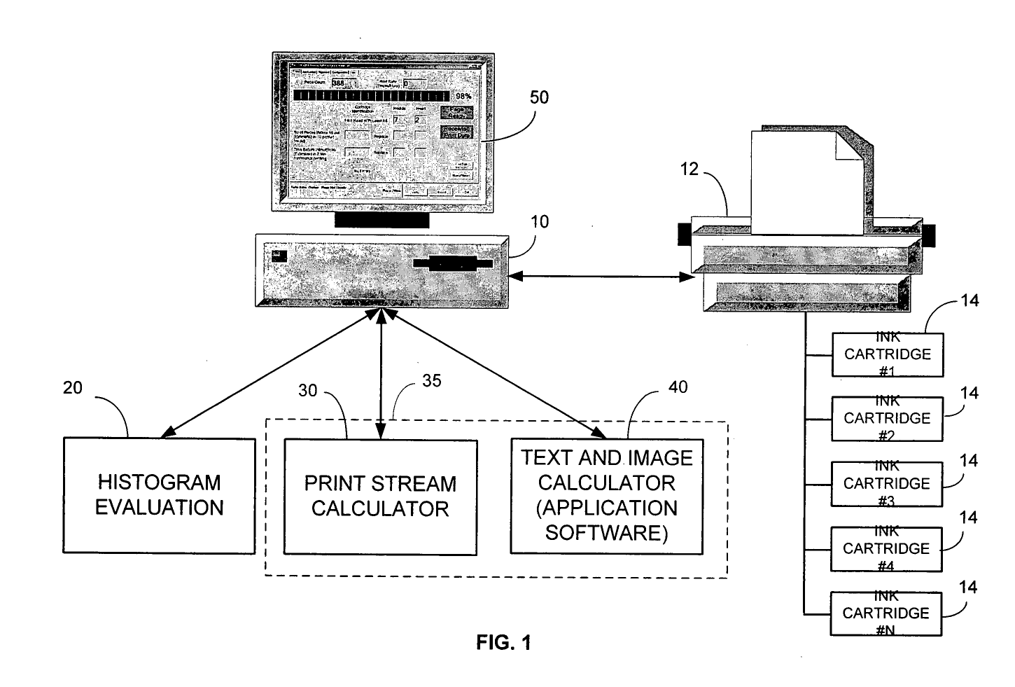

FIG. 1 depicts various system elements which may be used for anticipating or predetermining the usage of ink, whether such data is used to prepare for a print job or estimate costs associated therewith. As mentioned in the “Background of the Invention”, such information is particularly useful for to ensure that adequate ink resources are available to complete a print job. Alternatively, the ability to collect usage data in advance of performing a print job provides an operator or service provider with an ability to more closely and precisely estimate the job costs. It will also be recalled that ink consumption is, perhaps, the highest recurring cost associated with the use of ink-jet printer, i.e., higher than any other hardware and/or firmware consumable.

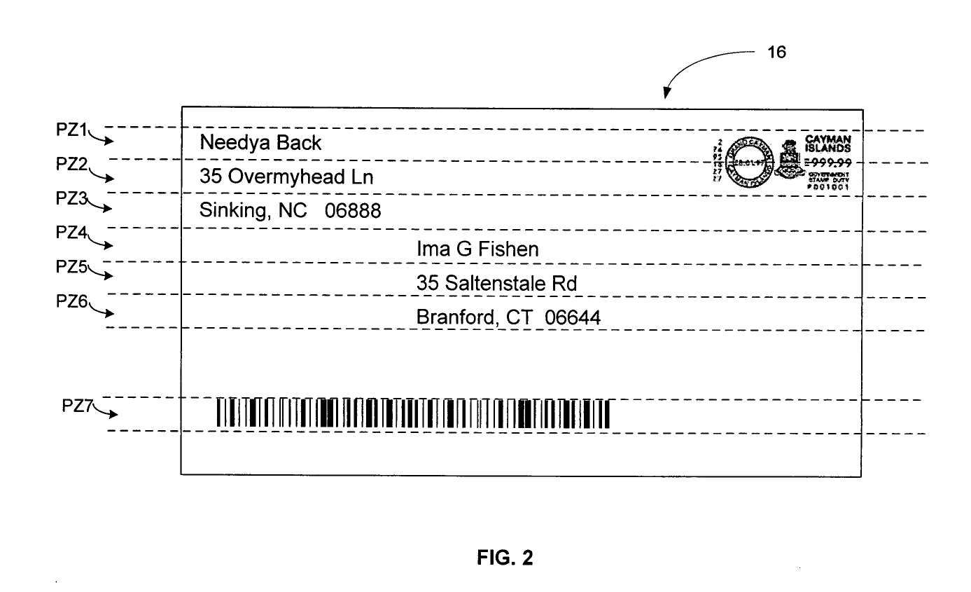

In FIG. 1, a computer processor 10 is connected to an ink-jet printer 12. In the described embodiment, the printer 12 is specifically adapted for high-speed in-line printing such as that employed for mailpiece production. In FIGS. 1 and 2, the printer 12 includes a plurality of ink cartridges 14 e.g., ink cartridges #1 through #N, dedicated to print in various “print zones”. For example, in FIG. 2, a mailpiece 16 includes seven (7) print zones, PZ1 through PZ7, each being dedicated to print horizontally along a row of predetermined height dimension (typically limited by the width or height dimension of the print head nozzle). In the illustrated embodiment, the first two zones PZ1 and PZ2 are dedicated to printing the first and second lines of the return address on the left-hand side of the mailpiece 16 and to printing the postage indicia on the right-hand side. Print zones PZ3-PZ6 are dedicated to printing other address information while print zone PZ7 may be assigned to printing the barcode symbology (i.e., generally the most ink-intensive zone or the zone which consumes the largest portion of ink).

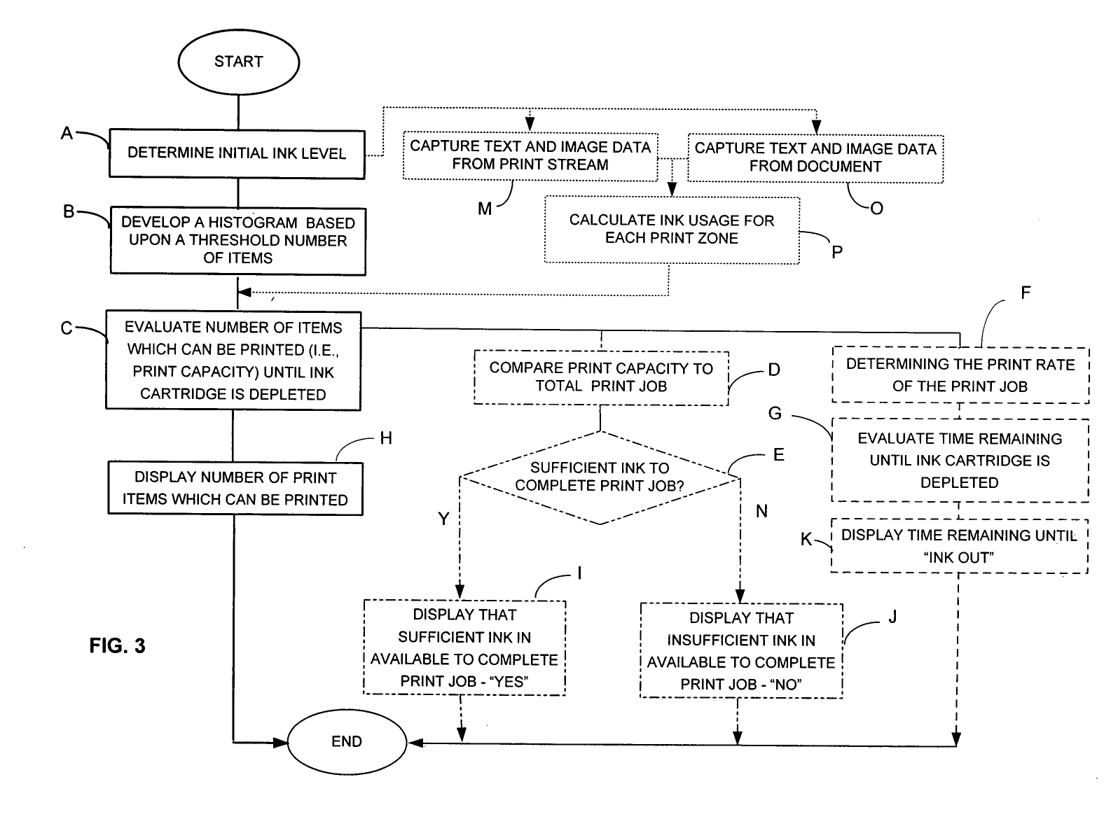

In FIGS. 1 and 3, the processor 10 includes program code 20, 30 or 40 which, may vary in the way information is derived/processed, but similarly predict ink consumption for the user/operator to make subsequent productivity and/or business decisions. Program code 20 relates to usage data derived from a histogram of sampled data (described in greater detail in subsequent paragraphs) while program code 30 and 40 relates to usage data derived from an evaluation of the electronic document (also described hereinafter). Program code 30 and 40 have similar functions and may be grouped as character recognition program code 35 inasmuch as each evaluates and/or recognizes the various characters (whether text/images from the print stream or an electronic version of the electronic document, e.g., an electronic document) produced by word processing application software such as MS Word® (MS Word is a registered Trademark of Microsoft Corporation located in Seattle, State of Washington, USA).

This information is presented on a computer monitor 50, though other display devices may be employed. Subsequent figures illustrate the display of preferred information, however, at this juncture, the various program code algorithms 20, 30, 40 for predictive ink usage/consumption will be described. While the program code algorithms 20, 30, 40 are collectively depicted in FIG. 3, the steps have been illustrated in a single figure for convenience and ease of comparison. The following paragraphs describe several alternative approaches to predictive ink usage.

### Histogram Prediction Methodology

In a first embodiment of the invention, usage data is collected empirically in small packages, i.e., histogram data, and subsequently extrapolated to develop data useful for predicting consumption. As used herein, the term “histogram” means a data sample or sampling of a statistically significant data set representative of the items to be printed. The number can be as few as several or several hundred, depending upon the total number of pieces to be printed. More specifically, in Step A, an initial ink level within an ink cartridge is determined. The initial ink level will typically begin with the level upon installation or “ink full”. Alternatively, the ink level may be that remaining subsequent to the previous print job. With respect to the latter, a conventional capacitance memory storage device or method may be employed to retain such historical ink level for subsequent use. In step B, a histogram of empirical data is obtained and evaluated based upon a threshold number of printed items. That is, by reviewing a threshold number of mailpieces X, e.g., 10, 50 or 100 mailpieces etc., an accurate prediction can be made concerning the number of remaining or additional mailpieces which can be printed based upon the ink remaining within the ink cartridge.

This methodology determines the ink usage with respect to printing a predetermined size of, for example, one hundred (100) mailpieces, i.e., X=100. Using this empirically derived data, a prediction can be made concerning the number of additional mailpieces which can be printed, assuming, of course, that the sample data is representative of the remaining pieces to be printed. While the described embodiment employs a threshold sample size of one-hundred (100) mailpieces, it will be appreciated that as more mailpieces are printed the histogram can be updated to improve the accuracy of the predicted values, i.e., the number of pieces which can be printed.

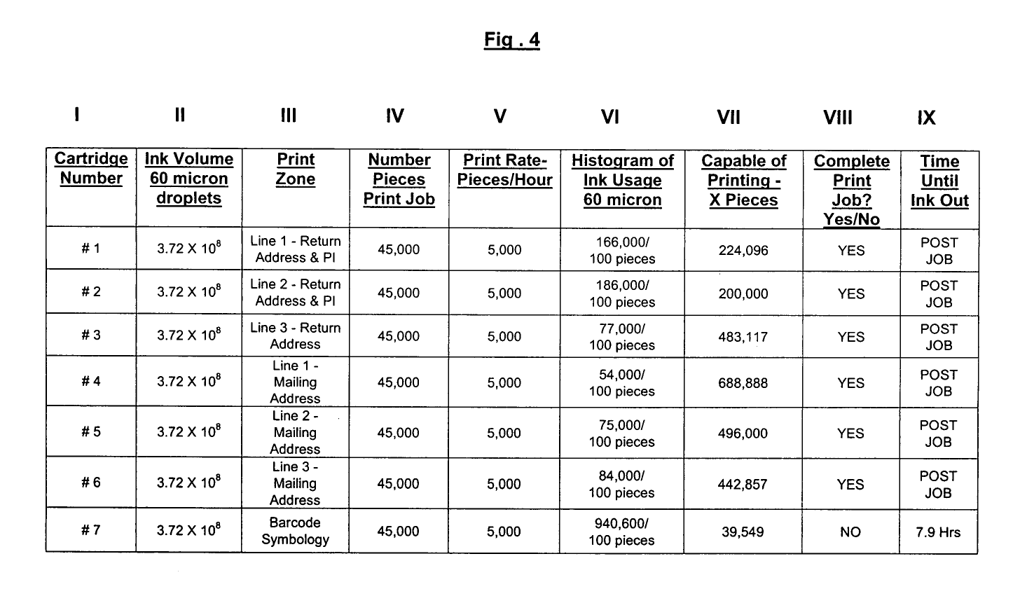

In FIG. 4, a table of input/output data associated with empirically derived histogram data is provided to illustrate how such data may be used to predict ink consumption. Therein, each row of data corresponds to an ink cartridge and associated print zone (columns I and III) Column II provides data concerning the total number of ink droplets contained in a full ink cartridge. For the purposes of this example, the total number of ink droplets was based upon a 42 milliliter ink cartridge delivering 60 micron ink droplets. Furthermore, Column VI provides information provided by the histogram of the first one-hundred (100) pieces of printed mail. By examining the data, it will be seen that the number of ink droplets for the first six (6) ink cartridges (#1-#6) does not exceed about 186,000 ink droplets for each 100 mailpieces evaluated. This information may be obtained by a simple counting algorithm provided within the processor of the ink cartridge. With respect to ink cartridge number seven (#7), however, a total of nearly 950,000 ink droplets were consumed while printing a sample of one-hundred (100) mailpieces.

Returning to step C of FIG. 2, the total number of items to be printed can be predicted by extrapolating the number of ink droplets in connection with the histogram data and the total number of ink droplets contained in the ink cartridge. Furthermore, in step D, a comparison can be made between the remaining print capacity and the size of the print job. For example, by examining Column VII of FIG. 4, it can be seen that the first six ink cartridges (#1-#6) will print as few as 224,000 pieces (i.e., ink cartridge #1) and as many as 688,888 pieces (i.e., ink cartridge #6). Based upon a review of the number of pieces to be printed in Column IV of FIG. 4, i.e., 45,000 pieces in the exemplary embodiment, in step E (see FIG. 2) a user/operator can anticipate that each of the ink cartridges #1-#6 will have sufficient ink to complete the print job On the other hand, with respect to ink cartridge #7, an evaluation of the histogram reveals that only 39,549 pieces may be completed before an “ink out” condition. Consequently, it can be predicted that ink cartridge #7 will have insufficient ink, to complete the print job, i.e., will be unable to print the 45,000 pieces of the print job.

Alternatively, in steps F and G, by determining the print rate of the print job in step F, the time remaining until the ink cartridge is depleted can be determined in step G. Inasmuch as most conventional high-speed printers maintain print rate information which can be used to estimate or predict, based upon an evaluation of the print capacity remaining, the time remaining before ink within one of the ink cartridges is depleted. For example, based upon a print rate of 5,000 pieces/hr as seen in Column V of FIG. 4, it can be determined that, during the present print job, the cartridge ink will be depleted in approximately 7.9 hours of a total 9.0 hour print job (seen in Column IX of FIG. 4). Consequently, a user/operator can use this information to ensure that operator assistance or intervention is available at this interval or juncture of the print run.

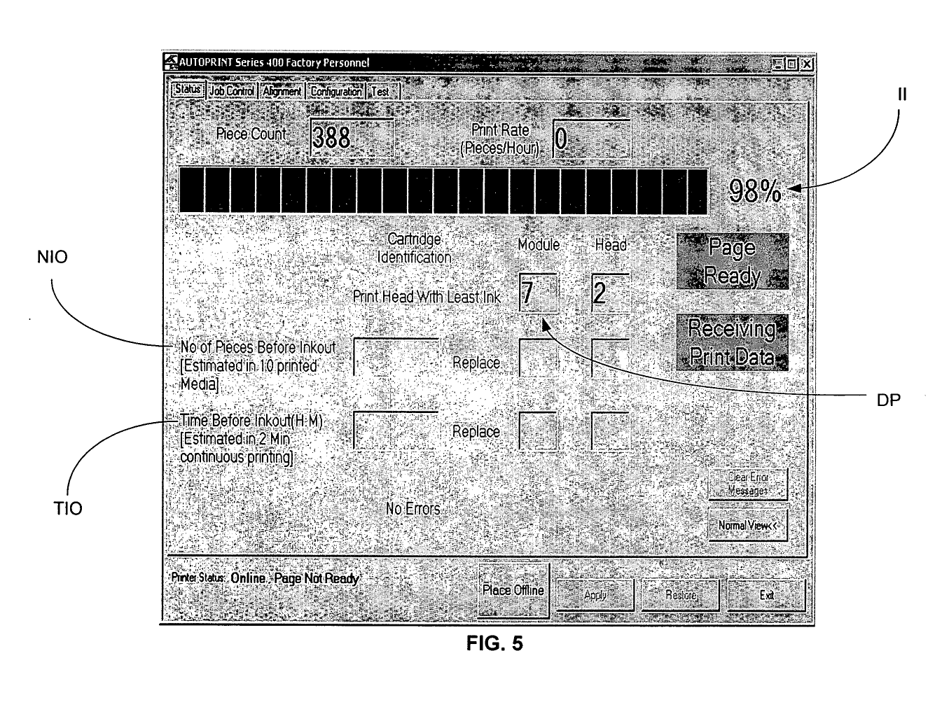

In steps H-K, the information derived from the various evaluation steps above, e.g., number of items which may be printed, time remaining, sufficiency of ink, etc., can be displayed on a system monitor 50. In FIGS. 1 and 5, a monitor can display an ink capacity field II indicating the amount of initial ink and, in step H, a print capacity field NIO indicative of the number of pieces which may be printed before an ink-out condition. In steps I and J, notification fields DP can be provided to indicate which cartridge will be depleted first or whether a particular ink cartridge has sufficient ink to complete a print job. In step K, a time remaining field TIO provides information concerning the time before an ink-out condition.

While the histogram prediction methodology has been described in the context of a print job having a known quantity of mailpieces, the histogram methodology is particularly useful in determining the number of remaining items/mailpieces which can be printed, irrespective the number of items anticipated in any particular print job. That is, assuming that the items to be printed have similar characteristics, e.g., the information to be printed in each print zone is of similar font, size and style, then a histogram, which samples a threshold number of items to be printed, can accurately predict the number of items to be printed before an ink-out condition. Consequently, when the number of items of a print job is unknown, the histogram methodology provides a useful tool for providing a user/operator with information concerning which ink cartridge will be depleted before other ink cartridges. Additionally, an accurate estimate of the number of pieces which can be printed, i.e., by that and other ink cartridges, can be displayed/provided.

### Character Recognition—Print Stream/Text Image Evaluation

It will be appreciated that the above described histogram methodology is not entirely predictive inasmuch as the technique relies upon the collection of empirical data to extrapolate data necessary to predict the number of mailpieces which can be printed. In FIGS. 1, 2 and 6, a fully or entirely predictive method may be employed based upon character recognition or an evaluation of the print stream or text/graphic images of an electronic version of the document.

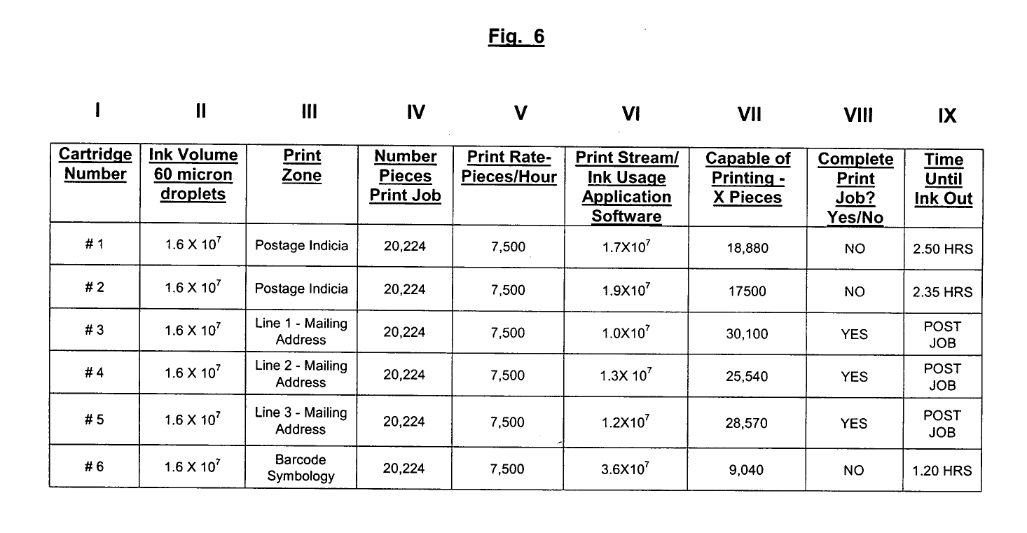

In step M of FIG. 2, usage data can be derived from characters of the electronic document. More specifically, text and image data can be derived from the print stream generated by the print driver software or from an electronic version of the document as produced by the application software. With respect to the former, print stream data may be employed to accurately calculate the anticipated ink usage by the ink cartridge. For example, the print stream can be parsed and analyzed to evaluate the various print zones of the print job. More specifically, the print stream can be parsed to identify the various return addresses, mailing addresses and barcode symbology which will be printed in the print job. Inasmuch as the number of ink drops can be calculated for each, the total volume of ink can be calculated in connection with these print zones and respective ink cartridges. Referring to FIG. 6, the total number of ink drops for the entire barcode symbology print zone (ink cartridge #6 in this example) is determined to be 3.6×10⁷ drops (Column VI of FIG. 6). However, based upon an initial ink volume of 1.6×10⁷ (Column II), it can be determined in step P (FIG. 2) that ink cartridge #6 will complete less than ½ of the total print job, or about 9,040 pieces (see Column VII) of the 20,224 total print job (Column IV). Consequently, before any portion of the print job is performed, this method can determine the print capacity for each ink cartridge as seen in Column VII, whether an ink cartridge will complete the print job in Column VIII and the time remaining until ink out in Column IX.

Similar to the previous histogram embodiment, the same steps C-G may be performed to evaluate and calculate the print capacity, sufficiency of ink, and time remaining before a particular cartridge is depleted of ink. Furthermore, the same information described in steps H-K may be displayed to advise a user/operator.

In yet another embodiment, a predictive ink usage software application can be employed to review the electronic version of the document i.e., the text and images to be printed, before being rendered by print driver software. Similar to the print stream methodology, each letter and image of a document can be reviewed to calculate the precise amount of ink which will be consumed to print the respective document. Upon combining the ink usage data associated with all documents to be printed, a highly accurate estimate can be obtained to determine whether the ink cartridges of each zone are adequately filled and/or which ink cartridge will be depleted before the others. In addition to determining whether a particular ink cartridge will be depleted before the completion of a print job, an estimate of the ink consumption can be obtained to properly allocate job costs or perform a cost estimate. Consequently, the predictive usage algorithms may be used to augment finance operations and estimates. Inasmuch as ink consumption is one of the principle factors which drive printing costs, the method provides the user with traceable and supportable cost allocation information.

In summary, various predictive methods provide a user/operator with data concerning the usage/consumption of ink during a print job. The method may employ empirically-derived or calculated data, directly from a print job to determine whether a print job can be completed with the currently-installed set of ink cartridges 14. Furthermore, a comparative analysis may be performed by evaluating the rate of ink consumption of each ink cartridge 14 based upon the ink usage data. That is, the comparative analysis can determine which of the ink cartridges 14 will be depleted before other ink cartridges 14 based upon the number of items which can be printed by each ink cartridge. For systems vary the print rate, i.e., wherein the printer provides or issues a print rate signal indicative of the number of items printed per unit time, the method may also determine the minimum time before an ink out condition. As such, the processor 10 will determine which ink cartridge 14 is associated with the minimum time before ink cartridge depletion and indicate, via the display 50 or other visual cueing device, which ink cartridge 14 will be depleted before other ink cartridges.

In addition to providing better operator oversight and management, the method also provides information useful for cost estimating and allocation. More specifically, a user/operator may determine, with a high degree of accuracy, the amount of ink which will be consumed to complete a print job. With this information, the user may provide accurate customer estimates or, more accurately, allocate costs across multiple print jobs.

Although the invention has been described with respect to a preferred embodiment thereof, it will be understood by those skilled in the art that the foregoing and various other changes, omissions and deviations in the form and detail thereof may be made without departing from the scope of this invention.

What is claimed is:

1. A method for predicting ink usage during a print job for an ink jet printer having at least one ink cartridge and displaying information in connection with ink usage on a system monitor; comprising the steps of:
determining the ink level in the ink cartridge to establish the total ink available in the ink cartridge;
developing a histogram of ink usage associated with a threshold number of printed items of the print job, the threshold number being less than the total number of items to be printed;
evaluating the number of items which can be printed before the ink cartridge is depleted based upon the total ink available and the histogram; and
displaying the number of items which can be printed by the ink cartridge on the system monitor to a user/operator.

2. The method according to claim 1 further comprising the step of:
determining a print rate associated with the print job;
evaluating the time remaining before the ink cartridge is depleted; and
displaying the time before the ink cartridge is depleted of ink on the system monitor to a user/operator.

3. The method according to claim 1 further comprising the step of:
evaluating whether an ink cartridge will be depleted before the print job will be completed; and
displaying the identity of the ink cartridge which will be depleted of ink before other ink cartridges to a user/operator.

4. The method according to claim 1 wherein the ink jet printer includes a plurality of ink cartridges and further comprising the step of:
evaluating which ink cartridge will be depleted before other ink cartridges; and
displaying the identity of the ink cartridge which will be depleted of ink before the other ink cartridges on the system monitor to a user/operator.

5. The method according to claim 1 further comprising the step of:
evaluating the ink usage associated with additional items to be printed:
updating the histogram; and
evaluating the number of items which can be printed based upon the updated histogram.

6. A method for predicting ink usage during a print job for an ink jet printer having at least one ink cartridge and displaying information in connection with ink usage on a system monitor; comprising the steps of:
determining the ink level in the ink cartridge to establish the total ink available in the ink cartridge;
evaluating electronically generated data associated with the document to determine a total amount of ink to be consumed by the ink cartridge when printing data associated with various print zones of the print job;
comparing the ink consumed by the ink cartridge to print the print job to the total ink available in the ink cartridge; and
displaying the number of items which can be printed by the ink cartridge on the system monitor to a user/operator.

7. The method according to claim 6 further comprising the step of:
rendering generating a print stream from print driver program code; and
wherein the electronically generated data is derived from the print stream.

8. The method according to claim 6 wherein the electronically generated data is derived from an electronic version of the document.

9. The method according to claim 6 further comprising the step of displaying whether the print job can be completed based upon the step of comparing the ink consumed by the ink cartridge to print the print job to the total ink available in the ink cartridge.

10. The method according to claim 6 further comprising the step of:
determining a print rate associated with the print job;
evaluating the time remaining before the ink cartridge is depleted based gram; and
displaying the time before the ink cartridge is depleted of ink on the system monitor to a user/operator.

11. The method according to claim 6 further comprising the step of:
evaluating whether an ink cartridge will be depleted before the print job will be completed; and
displaying the ink cartridge which will be depleted of ink before other ink cartridges to a user/operator.

12. The method according to claim 7 further comprising the step of:
determining a print rate associated with the print job;
evaluating the time remaining before the ink cartridge is depleted based gram; and
displaying the time before the ink cartridge is depleted of ink on the system monitor to a user/operator.

13. The method according to claim 7 further comprising the step of:
evaluating whether an ink cartridge will be depleted before the print job will be completed; and
displaying the ink cartridge which will be depleted of ink before other ink cartridges to a user/operator.

14. The method according to claim 8 further comprising the step of:
determining a print rate associated with the print job;
evaluating the time remaining before the ink cartridge is depleted based gram; and
displaying the time before the ink cartridge is depleted of ink on the system monitor to a user/operator.

15. The method according to claim 8 further comprising the step of:
evaluating whether an ink cartridge will be depleted before the print job will be completed; and
displaying the ink cartridge which will be depleted of ink before other ink cartridges to a user/operator.

16. A system for predicting ink usage of an in-line mailpiece printer and displaying information in connection with ink usage, comprising:
a printer having a plurality of ink cartridges for printing dedicated print zones of a mailpiece;
a processor connected to the printer and including program code for determining the current ink level to establish the total ink available in the ink cartridge and developing usage data in connection with ink consumption associated with the print job, and
a display connected to the processor to indicate the usage data on the system monitor to a user/operator.

17. The system according to claim 16 wherein the processor obtains usage data from a histogram of printed mailpieces.

18. The system according to claim 16 wherein the processor obtains usage data from an evaluation of the print stream data employed to print the mailpiece.

19. The system according to claim 16 wherein the processor obtains usage data from an evaluation of an electronic version of the mailpiece.

20. The system according to claim 16 wherein the processor includes program code predicting the cost of ink consumed upon completing the print job and the display provides cost estimate data to a user/operator.

21. The system according to claim 16
wherein the processor includes program code to evaluate the number of items which can be printed before the ink cartridge is depleted based upon the total ink available and the histogram; and
wherein the display indicates the number of items which can be printed by the ink cartridge to a user/operator.

22. The system according to claim 16
wherein the printer issues a rate signal indicative to the print rate that items are printed,
wherein the processor is responsive to the rate signal to evaluate the number of items which can be printed before the ink cartridge is depleted based upon the total ink available; and
wherein the display indicates the time before the ink cartridge will be depleted of ink on the system monitor to a user/operator.

23. The system according to claim 16
wherein the processor includes program code to evaluate whether an ink cartridge will be depleted before the print job will be completed; and
wherein the display indicates the identity of the ink cartridge which will be depleted of ink before other ink cartridges to a user/operator.

24. A method for monitoring ink usage in an ink jet printer having a plurality of ink cartridges, and displaying information in connection with such ink usage on a system monitor; comprising the steps of:
determining the ink level in the ink cartridges to establish the total ink available in each ink cartridge;
evaluating the rate of ink consumption of each ink cartridge based upon ink usage data of the print job;
calculating the number of items which can be printed before each of the ink cartridges is depleted based upon the total ink available and the ink usage data; and
performing a comparative analysis, based upon the number of items which can be printed in connection with each ink cartridge, to determine which of the ink cartridges will be depleted before other ink cartridges; and
displaying which of the ink cartridges will be depleted before other ink cartridges on the system monitor to a user/operator.

25. The method according to claim 24 wherein the usage data is derived from a histogram of printed mailpieces.

26. The method according to claim 24 wherein the usage data is derived from an evaluation of the print stream data employed to print the mailpiece.

27. The method according to claim 24 wherein the usage data is derived from an evaluation of an electronic version of the mailpiece.

28. The method according to claim 24 wherein the printer issues a rate signal indicative to the print rate that items are printed, and wherein the step of performing a comparative analysis includes the steps of:
determining the time before each ink cartridge will be depleted of ink based upon the rate signal of the printer;
determining which of the times associated with ink cartridge depletion is a minimum; and
displaying on the system monitor to a user/operator which ink cartridge is associated with the minimum time to identify when the first of the ink cartridges to be depleted of ink.
